(19) United States
(12) Patent Application Publication
(10) Pub. No.: US 2024/0151697 A1
(43) Pub. Date: May 9, 2024

(54) Method for Analysis of Residual Lithium Compounds in Positive Electrode Active Material

(71) Applicant: LG Chem, Ltd., Seoul (KR)

(72) Inventors: Kyeongrak Kim, Daejeon (KR); Dong Wook Lee, Daejeon (KR); Min Hwan Jung, Daejeon (KR); Youkyong Seo, Daejeon (KR)

(73) Assignees: LG Chem, Ltd., Seoul (KR); LG Chem, Ltd., Seoul (KR)

(21) Appl. No.: 18/284,354

(22) PCT Filed: Nov. 15, 2022
(86) PCT No.: PCT/KR2022/017993

§ 371 Date: Sep. 27, 2023

(30) Foreign Application Priority Data
Nov. 16, 2021 (KR) 10-2021-0157632
Nov. 14, 2022 (KR) 10-2022-0151580

(51) Int. Cl. G01N 31/12; G01N 31/16; H01M 10/42

(52) U.S. Cl. CPC G01N 31/12; G01N 31/168; H01M 10/4285

(57) ABSTRACT

A method for analysis of residual lithium compounds in a positive electrode active material for a lithium secondary battery comprises the steps of: analyzing a sample of a positive electrode active material using an oxygen/nitrogen/hydrogen analyzer (ONH analyzer) and a Karl Fischer analyzer to determine the amount of the H component; analyzing the sample using a carbon/sulfur analyzer (CS analyzer) to determine the amount of the C component and the S component; analyzing the sample using an inductively coupled plasma optical emission spectrometer (ICP-OES) to determine the amount of the Li component; and calculating the amount of each of LiOH, Li₂CO₃, and Li₂SO₄ in the sample using the quantification results of the H, C, and S components, and calculating the amount of Li₂O in the sample using the quantification result of the Li component.

### CROSS-REFERENCE TO RELATED APPLICATIONS

The present application is a national phase entry under 35 U.S.C § 371 of International Application No. PCT/KR2022/017993 filed on Nov. 15, 2022 which claims the benefit of priority based on Korean Patent Application No. 10-2022-0151580, filed on Nov. 14, 2022 and on Korean Patent Application No. 10-2021-0157632 filed on Nov. 16, 2021, all contents of which are incorporated herein by reference

### TECHNICAL FIELD

The present disclosure relates to a method for analyzing a residual lithium compound not involved in charging and discharging in a cathode active material for a lithium secondary battery.

### BACKGROUND ART

A lithium secondary battery generally has the structure that an electrode assembly comprising a cathode and an anode containing an electrode active material capable of intercalating/discharging lithium ions, and a separator for separating the two electrodes is impregnated with an electrolyte solution as a medium of transferring lithium ions. The battery is charged and discharged as lithium ions move between the anode and cathode through the electrolyte. The electrode is generally manufactured by coating a foil-shaped current collector with a slurry containing an electrode material (e.g., an active material, a conductive material and a binder) to dry same, and forming an active material layer through a pressing process.

The performance of such a secondary battery is influenced by various factors (e.g., the components such as a cathode, an anode, a separator and an electrolyte, the composition of each component, and charging and discharging characteristics thereof). In particular, since a lithium by-product generated during the manufacturing process of the cathode active material, i.e., a residual lithium compound present in the cathode active material but not involved in charging and discharging, may impair the performance of the cathode, analysis on the lithium by-product is important for evaluating the performance of the battery.

In general, LiOH, Li₂CO₃, Li₂SO₄, and Li₂O are regarded as four major residual compounds of the cathode active material. Conventionally, a wet method of stirring a cathode active material sample in water to elute a residual compound and then measuring the pH of the filtrate was performed in order to analyze the residual components.

However, this wet method has the problems that, since Li₂O mostly turns into LiOH when in contact with water, Li₂O and LiOH are hardly distinguished from each other; and, since the pH of Li₂SO₄ cannot be measured, only the pH of LiOH and Li₂CO₃ among the four residual compounds are measured. In addition, when other metals are coated on the surface of the cathode active material, multiple peaks rather than a single peak appear during pH titration, which renders accurate analysis difficult.

### SUMMARY OF TECHNOLOGY

### Technical Problem

Accordingly, the object of the present disclosure is to provide a method for analyzing all four residual lithium compounds of LiOH, Li₂CO₃, Li₂SO₄ and Li₂O present in a cathode active material for a lithium secondary battery.

### Technical Solution

An aspect of the present invention provided is a method for analyzing residual lithium compounds in the cathode active material for the lithium secondary battery, an analysis method comprising the following steps:
analyzing a cathode active material sample with an oxygen nitrogen hydrogen analyzer (ONH analyzer) and a Karl Fischer analyzer to measure the amount of an H component;
analyzing the sample with a carbon-sulfur analyzer (CS analyzer) to measure the amounts of C and S components;
analyzing the sample with an inductively coupled plasma optical emission spectrometer (ICP-OES) to measure the amount of a Li component; and
calculating each amount of LiOH, Li₂CO₃ and Li₂SO₄ in the sample by using the measurement results of the H, C and S components, and calculating the amount of Li₂O in the sample by using the measurement results of the Li component.

An aspect of the present invention provides a process of measuring the amount of H by the ONH and Karl Fischer analysis methods when calculating the amount of LiOH in the cathode active material and then correcting for changes in the amount due to moisture.

In addition, an aspect of the present invention provides a cathode active material for a lithium secondary battery analyzed by the above-described methods, wherein the amount of residual LiOH is 0.1 to 0.4% by weight, the amount of residual Li₂CO₃ is 0.1 to 1.0% by weight, and the amount of residual Li₂SO₄ is 0.1% to 1.3% by weight, and the amount of residual Li₂O is 0.2 to 0.5% by weight, based on the total amount of the cathode active material.

### Advantageous Effects

According to an aspect of the present invention, the cathode active material sample is subjected to ONH analysis, CS analysis and ICP-OES analysis, respectively, and the amounts of all four residual lithium compounds (i.e., LiOH, Li₂CO₃, Li₂SO₄ and Li₂O) present in the cathode active material may be analyzed by using the amounts of H, C, S, and Li measured therefrom. In particular, unlike a conventional wet method through pH titration, the ONH analysis and CS analysis are performed in a dry method such that the amounts of Li₂O and LiOH are separately measured, and the amount of Li₂SO₄ not pH titrated in the wet method is also measured, thereby contributing to accurate evaluation of the performance of the lithium secondary battery.

### DETAILED DESCRIPTION

The terms or words used in the specification and claims of the present invention should not be construed as being limited to have ordinary or dictionary meanings, but be interpreted to have meanings and concepts consistent with the technical idea of the present invention, based on the principle that the inventor(s) of a patent may appropriately define the concept of terms in order to explain the invention in the best way.

In addition, the features exemplified in the embodiments described in the specification of the present invention are only one of the most preferred embodiments of the present invention and do not represent all of the technical ideas of the present invention. Thus, it should be understood that there may be various equivalents and variations that can replace them at the time of the filing date of the present application.

One embodiment of the present invention relates to a method for analyzing all residual lithium compounds (i.e., LiOH, Li₂CO₃, Li₂SO₄ and Li₂O) in the cathode active material for the lithium secondary battery.

The cathode active material to be analyzed by an embodiment of the present invention is a compound in which lithium ions are intercalated in a cathode of a lithium secondary battery, which may comprise, for example, at least one selected from the group consisting of LiCoO₂, LiNiO₂, LiMn₂O₄, LiCoPO₄, LiFePO₄, and LiNi_{1-x-y-z}CoₓM1_{y}M2_{z}O₂ (wherein M1 and M2 are independently any one selected from the group consisting of Al, Ni, Co, Fe, Mn, V, Cr, Ti, W, Ta, Mg and Mo; and x, y, and z are independently atomic fractions of oxide composition elements, and 0≤x≤0.5, 0≤y≤0.5, 0≤z≤0.5, and 0≤x+y+z≤1).

Such a cathode active material is produced into a crystal having a cubic spinel structure or a layered structure by mixing a precursor solution containing transition metals such as Ni, Co and Mn with a lithium source (e.g., Li₂CO₃, LiNO₃, Li₂O and Li₂SO₄) and heat-treating the mixture at a temperature of 900° C. or higher. Li not contained in the crystal structure may react with CO₂ present in the air during the heat treatment process to become Li₂CO₃ or may react with water to generate LiOH. In addition, the unreacted lithium source used to produce the active material may remain on the surface of the final active material. In general, four lithium compounds (i.e., LiOH, Li₂CO₃, Li₂SO₄ and Li₂O) are regarded as by-products present in the cathode active material but not involved in charging and discharging. In order to secure the performance of the cathode, accurate analysis on the four residual lithium compounds is required.

To this end, in the present application, the cathode active material samples are prepared and introduced into an oxygen nitrogen hydrogen analyzer (ONH analyzer) and a carbon-sulfur analyzer (CS analyzer) operated in a dry method, and an ICP-OES analyzer operated in a wet method, respectively, to measure the amounts of H, C, S and Li components and calculate the amounts of LiOH, Li₂CO₃, Li₂SO₄ and Li₂O through the measured values.

Specifically, the ONH analyzer is a device for detecting oxygen, nitrogen and hydrogen gas components discharged after melting the samples in a heating furnace, and the cathode active material samples may be introduced in the form of dried particles into the ONH analyzer commonly used in the art to measure the amount of the H component contained in the samples.

The CS analyzer is a device for detecting the amounts of carbon and sulfur produced by burning samples in an oxygen stream, and the cathode active material samples may be introduced in the form of dried particles together with a flame retardant into the ceramic heating furnace of the CS analyzer commonly used in the art, and oxygen gas may be supplied from a device for inducing a high frequency to measure the amounts of the C component and S component contained in the samples.

When using the ONH analyzer and the CS analyzer, the cathode active material samples do not contact with moisture allowing the amounts of Li₂O and LiOH to be separately measured. As such, this method may overcome the limitation of the conventional analysis method of measuring the amount of residual lithium in the cathode active material by using pH titration in a wet method where Li₂O changes to LiOH due to contact with moisture such that only the total amounts of LiOH and Li₂CO₃ may be measured. In addition, Li₂SO₄ that is not pH titrated in the wet method may be analyzed by using the amount of the S component measured by the CS analyzer.

In one embodiment of the present invention, the amount of LiOH is calculated by using the results of the H component measured by the ONH analysis, and the calculated amount of LiOH may be 0.1 to 0.4% by weight, based on the total weight of the cathode active material.

In addition, the amounts of Li₂CO₃ and Li₂SO₄ are calculated by using the results of the C component and the S component measured by the CS analysis, respectively, and the amount of Li₂CO₃ may be 0.1 to 1.0% by weight, based on the total weight of the cathode active material, and the amount of Li₂SO₄ may be 0.1 to 1.3% by weight, based on the total weight of the cathode active material.

On the other hand, the ICP-OES analysis may be performed by using a solution obtained by dispensing a cathode active material sample and dissolving same in ultrapure water. Specifically, for example, the ICP-OES analysis may comprise impregnating 1:50 to 1:500 parts by weight of the cathode active material sample and ultrapure water, for example, 1:50 to 300 parts by weight, 1:50 to 200 parts by weight or 1:80 to 150 parts by weight, for 1 to 60 minutes, for example 1 to 40 minutes, 5 to 30 minutes, or 5 to 15 minutes. The value analyzed by the ICP-OES indicates the total amount of lithium (Li wt %) in the cathode active material, i.e., the amounts of all Li compounds such as LiOH, Li₂CO₃, Li₂SO₄ and Li₂O.

The ICP-OES analysis is performed by applying high thermal energy to the sample by using a high-temperature plasma induced by an argon gas as an inert gas to generate atoms and ions in the sample in an excited state, and then detecting the line emitted by the atoms and ions returning to a low energy level to analyze the components, which allows the total residual Li component contained in the cathode active material sample to be measured.

In one embodiment of the present invention, the treatment of the cathode active material sample with ultrapure water may be performed by adding ultrapure water in a range of 0.1 to 100 ml, based on 100 mg of the dispensed sample and then stirring the mixture at room temperature for about 5 minutes. After filtering the solution treated with ultrapure water to remove undissolved components, component analysis may be performed by introducing the remaining filtrate into an ICP-OES analyzer commonly used in the art.

The amount of Li₂O is calculated by subtracting the amount of Li corresponding to LiOH, Li₂CO₃ and Li₂SO₄ from the total residual Li component in the cathode active material sample measured by the ICP-OES analysis, and the calculated amount of Li₂O may be 0.2 to 0.5% by weight, based on the total weight of the cathode active material.

In the present application, the order of the steps of the ICP-OES analysis, CS analysis and ONH analysis is not particularly limited.

In order to solve the problem that, since Li₂O is mostly changed to LiOH when in contact with water, Li₂O and LiOH are hardly distinguished from each other, the ONH analysis and Karl Fischer analysis are performed on the cathode active material containing water, and the accuracy of measuring the amount of LiOH is improved through the correction of excluding the amount of LiOH generated due to contact with moisture, based on the amount value of water measured by the Karl Fischer analysis.

Specifically, the amount of LiOH in the cathode active material may be calculated as in Equation 1 to correct for changes in the amount due to moisture.

$$LiOH ( wt \% ) = \frac{{\{ ( H 1 , wt \% ) - ( H 2 , wt \% ) \}}^{*} {MW}_{LiOH}}{{AM}_{H}} \qquad [ Equation 1 ]$$

wherein,
H1 is the amount of hydrogen (wt %) analyzed by the ONH analyzer,
H2 is the amount of hydrogen (wt %) analyzed by the Karl Fischer method,
MW_{LiOH} is the weight average molecular weight of LiOH, and
AM_{H} is the atomic mass of hydrogen. The above-described analysis process may comprise analyzing the amounts of all four residual lithium compounds (i.e., LiOH, Li2CO3, Li2SO4 and Li2O) present in the cathode active material of the lithium secondary battery but not involved in charging and discharging, and the performance of the cathode and lithium secondary battery may be accurately evaluated by applying the analyzed amounts of the residual lithium compounds.

Accordingly, an embodiment of the present invention further provides a cathode active material for a lithium secondary battery analyzed by the above-described method.

In the cathode active material, the amount of residual LiOH may be 0.1 to 0.4% by weight, the amount of residual Li₂CO₃ may be 0.1 to 1.0% by weight, the amount of residual Li₂SO₄ may be 0.1 to 1.3% by weight, and the amount of residual Li₂O may be 0.2 to 0.5% by weight, based on the total amount of the cathode active material.

Hereinafter, embodiments will be described in detail to aid understanding of the present invention. However, the embodiments according to the present invention may be modified in many different forms, and the scope of the present invention should not be construed as being limited to the following examples. The embodiments of the present invention are provided to more completely explain the present invention to those skilled in the art.

### Examples

(Step 1) ONH Analysis

First, four types of cathode active material samples of Li[Ni_{0.86}Co_{0.05}Mn_{0.07}Al_{0.02}]O₂ (Samples 1 and 2: calcinated products; and Samples 3 and 4: washed products) were prepared for analysis.

10 to 50 mg of each of the samples (in a solid state) was dispensed, introduced into the heating furnace of an ONH analyzer (ONH836, LECO) and melted at 2,200° C., and the discharged hydrogen gas was moved together with a carrier gas (He) and analyzed to measure the amount of H in the samples.

(Step 2) CS Analysis

200 to 300 mg of each of the samples (in a solid state) was dispensed, introduced into a CS analyzer (CS844, LECO) and then calcined together with a flame retardant under an oxygen atmosphere to obtain a carbon (C) compound and a sulfur (S) compound, and such compounds were analyzed to measure the amounts of C component and S component in the samples.

(Step 3) ICP-OES Analysis

100 to 200 mg of each of the samples was dispensed and dissolved in 10 ml of ultrapure water.

After 5 minutes, each sample solution was filtered with a 0.45 μm PTFE filter to remove undissolved components, and then the remaining filtrate (i.e., a supernatant) was introduced into an ICP-OES instrument (e.g., AVIO 500, Perkin Elmer) to perform component analysis. Thus, the components of the total residual Li contained in the samples were measured.

<Conditions for ICP-OES Analysis>
Forward Power: 1300 W
Torch Height: 15 mm
Plasma gas flow: 15.00 L/min
Sample gas flow: 0.8 L/min
Assist gas flow: 0.20 L/min
Pump speed: 1.5 m/min

(Step 4) Calculation of the Amounts of LiOH, Li₂CO₃, Li₂SO₄ and Li₂O

The amounts of LiOH, Li₂CO₃ and Li₂SO₄ in the samples were calculated by using the measurement results of the H, C and S components, respectively, in the four samples, and the amount of Li corresponding to LiOH, Li₂CO₃ and Li₂SO₄ was subtracted from the total residual Li components to calculate the amount of Li₂O. The results are shown in Table 1 below.

TABLE 1

| | | | | | | | | | | | ICP- | | |
|---|---|---|---|---|---|---|---|---|---|---|---|---|---|
| | CS analyzer | | | | | | CS analyzer | | | Li of | OES | | |
| | | | Li | ONH analyzer | | | | | Li | LC + | Total | Li | |
| | | | of | | | Li of | | | of | LH + | residual | of | |
| | C | LC | LC | H | LH | LH | S | LS | LS | LS | Li | LO | LO |
| Sample | 1141 | 7019 | 1319 | 151 | 3587 | 1040 | 3518 | 12062 | 1523 | 3881 | 5676 | 1794 | 3863 |
| 1 | | | | | | | | | | | | | |
| Sample | 1546 | 9511 | 1787 | 119 | 2827 | 819 | 3770 | 12926 | 1632 | 4238 | 6342 | 2104 | 4529 |
| 2 | | | | | | | | | | | | | |
| Sample | 186 | 1144 | 215 | 66 | 1568 | 454 | 332 | 1138 | 144 | 813 | 1974 | 1161 | 2499 |
| 3 | | | | | | | | | | | | | |
| Sample | 289 | 1778 | 334 | 81 | 1924 | 558 | 347 | 1190 | 150 | 1042 | 2032 | 990 | 2130 |
| 4 | | | | | | | | | | | | | |

* The unit of measurement: ppm
** LH: LiOH, LC: Li₂CO₃, LS: Li₂SO₄, LO: Li₂O

Table 1 above shows that Samples 1 and 2 that are the calcinated products obtained by calcinating the precursors had a large amount of residual lithium, and Samples 3 and 4 that are washed products obtained by washing and drying the calcinated products had a small amount of residual lithium.

(Step 5)

A blank was measured three times by using a graphite crucible. Calibration was performed by using 0, C, and N standard samples. 0.02 g of the non-dried cathode active material of Li[Ni_{0.86}Co_{0.05}Mn_{0.07}Al_{0.02}]O₂ was placed in a tin capsule and sealed. The tin capsule was then put into a nickel basket. The nickel basket was put into the sample inlet to perform H analysis. Quantitative analysis on the sample was repeatedly performed twice or more.

1 g of the cathode active material of Li[Ni_{0.86}Co_{0.05}Mn_{0.07}Al_{0.02}]O₂ was dispensed into a sample bottle, sealed with a rubber stopper, and loaded into an instrument (e.g., C30 coulometric KF titrator, Mettler toledo) together with an empty bottle sample. After vaporizing the moisture while heating the sample at 200° C. for 600 seconds, the amount of moisture was measured by iodine titration. After correcting for moisture, the amount of LiOH was calculated as in Equation 1.

$$LiOH ( wt \% ) = \frac{{\{ ( H 1 , wt \% ) - ( H 2 , wt \% ) \}}^{*} {MW}_{LiOH}}{{AM}_{H}} \qquad [ Equation 1 ]$$

wherein,
H1 is the amount of hydrogen (wt %) analyzed by the ONH analyzer,
H2 is the amount of hydrogen (wt %) analyzed by the Karl Fischer method,
MW_{LiOH} is the weight average molecular weight of LiOH, and
AM_{H} is the atomic mass of hydrogen.

### Comparative Examples

After preparing four types of cathode active material samples of Li[Ni_{0.86}Co_{0.05}Mn_{0.07}Al_{0.02}]O₂, 5 g of each sample was dispensed and added to 1000 ml of ultrapure water to dissolve same.

After each sample solution was filtered through a 0.45 μm PTFE filter to remove undissolved components, pH titration was performed on the remaining filtrate (i.e., a supernatant) to measure the amounts of LiOH and Li₂CO₃ in the sample.

The amount results of the components calculated in the examples and comparative examples and indicated by the unit of weight % (wt %) are shown in Table 2 below.

TABLE 2

| | | | | | | Comparative | |
|---|---|---|---|---|---|---|---|
| | Examples (wt %) | | | | | Examples (wt %) | |
| | LC | LS | LH | LO | LH + | LC | LH |
| | (Li₂CO₃) | (Li₂SO₄) | (LiOH) | (Li₂O) | LO | (Li₂CO₃) | (LiOH) |
| Sample 1 | 0.702 | 1.206 | 0.359 | 0.386 | 0.745 | 0.699 | 0.805 |
| Sample 2 | 0.951 | 1.293 | 0.283 | 0.453 | 0.736 | 0.987 | 0.823 |
| Sample 3 | 0.114 | 0.114 | 0.157 | 0.250 | 0.407 | 0.144 | 0.385 |
| Sample 4 | 0.178 | 0.119 | 0.192 | 0.213 | 0.405 | 0.208 | 0.381 |

From Table 2 above, the amounts of all four residual lithium compounds of LiOH, Li₂CO₃, Li₂SO₄ and Li₂O can be measured by combining the results of component analysis performed on a cathode active material sample in dry and wet methods according to the examples. Further, it is confirmed that the amount of residual LiOH is 0.1 to 0.4% by weight, the amount of residual Li₂CO₃ is 0.1 to 1.0% by weight, the amount of residual Li₂SO₄ is 0.1 to 1.3% by weight, and the amount of residual Li₂O is 0.2 to 0.5% by weight, based on the total amount of the sample.

On the other hand, in the comparative examples, since only wet pH titration analysis was performed, only the amounts of LiOH and Li₂CO₃ were measured. It is confirmed that the amount of LiOH measured according to the comparative examples includes the amount of Li₂O changed to LiOH and is similar to the sum of the amounts of LiOH and Li₂O according to the examples. Accordingly, the total amount of LiOH, Li₂O and Li₂CO₃ measured according to the examples was compared with the total amount of LiOH and Li₂CO₃ measured according to the comparative examples, as the amount of residual lithium, and the results are shown in Table 3 below.

TABLE 3

| | | Comparative | |
|---|---|---|---|
| | Examples (wt %) | Examples (wt %) | |
| | LC + LH + LO | LC + LH | RSD (%)¹⁾ |
| Sample 1 | 1.447 | 1.504 | 2.732 |
| Sample 2 | 1.687 | 1.810 | 4.974 |
| Sample 3 | 0.521 | 0.529 | 1.077 |
| Sample 4 | 0.583 | 0.589 | 0.724 |

¹⁾RSD (Relative standard deviation) = Standard deviation/average × 100

From Table 3 above, it is confirmed that the relative standard deviation (RSD) of the amount of residual lithium of the examples is within 5% as compared to the comparative examples.

1. A method for analyzing a residual lithium compound in a cathode active material for a lithium secondary battery, comprising:
analyzing a cathode active material sample with an Oxygen/Nitrogen/Hydrogen analyzer and a Karl Fischer analyzer to measure an amount of hydrogen components;
analyzing the cathode active material sample with a Carbon-Sulfur analyzer to measure an amount of carbon components and an amount of sulfur components;
analyzing the cathode active material sample with an Inductively Coupled Plasma Optical Emission Spectrometer to measure an amount of lithium components; and
calculating an amount of each of LiOH, Li₂CO₃ and Li₂SO₄ in the cathode active material sample by using a measurement result of the amount of each of the hydrogen, carbon, and sulfur components, and calculating an amount of Li₂O in the cathode active material sample by using a measurement result of the amount of lithium components, and
calculating the amount of LiOH by Equation 1:
$$LiOH ( wt \% ) = \frac{{\{ ( H 1 , wt \% ) - ( H 2 , wt \% ) \}}^{*} {MW}_{LiOH}}{{AM}_{H}} \qquad [ Equation 1 ]$$
wherein,
H1 is the amount of hydrogen components (wt %) analyzed by the Oxygen/Nitrogen/Hydrogen analyzer,
H2 is the amount of hydrogen components (wt %) analyzed by the Karl Fischer analyzer,
MW_{LiOH} is a weight average molecular weight of LiOH, and
AM_{H} is an atomic mass of hydrogen.

2. The method for analyzing a residual lithium compound of claim 1, wherein the Inductively Coupled Plasma Optical Emission Spectrometer analysis is performed with a solution having the cathode active material sample dissolved in an ultrapure water.

3. The method for analyzing a residual lithium compound of claim 1, wherein the amount of LiOH calculated by using the measurement result of the amount of hydrogen components measured by the Oxygen/Nitrogen/Hydrogen analysis is 0.1 to 0.4% by weight, based on a total weight of the cathode active material.

4. The method for analyzing a residual lithium compound of claim 1, wherein the amount of Li₂CO₃ calculated by using the measurement result of the amount of carbon components measured by the Carbon-Sulfur analysis is 0.1 to 1.0% by weight, based on a total weight of the cathode active material.

5. The method for analyzing a residual lithium compound of claim 1, wherein the amount of Li₂SO₄ calculated by using the measurement result of the amount of sulfur components measured by the Carbon-Sulfur analysis is 0.1 to 1.3% by weight, based on a total weight of the cathode active material.

6. The method for analyzing a residual lithium compound of claim 1, wherein the amount of Li₂O calculated by using the measurement result of the amount of Li components measured by the Inductively Coupled Plasma Optical Emission Spectrometer analysis is 0.2 to 0.5% by weight, based on a total weight of the cathode active material.

7. The method for analyzing a residual lithium compound of claim 6, wherein the amount of Li₂O is calculated by subtracting the amount of Li components from each of LiOH, Li₂CO₃ and Li₂SO₄ from a total residual amount of Li components in the cathode active material sample measured by the Inductively Coupled Plasma Optical Emission Spectrometer analysis.

8. The cathode active material for the lithium secondary battery analyzed by the method according to claim 1, wherein an amount of a residual LiOH is 0.1 to 0.4% by weight, an amount of a residual Li₂CO₃ is 0.1 to 1.0% by weight, an amount of a residual Li₂SO₄ is 0.1% to 1.3% by weight, and an amount of a residual Li₂O is 0.2 to 0.5% by weight, based on the total amount of the cathode active material.
